(19) United States
(12) Patent Application Publication
(10) Pub. No.: US 2011/0257978 A1
(43) Pub. Date: Oct. 20, 2011

(54) Time Series Filtering, Data Reduction and Voice Recognition in Communication Device

(75) Inventors: Robert J. Jannarone, San Diego, CA (US); John T. Tatum, Atlanta, GA (US); Leronzo Lidell Tatum, College Park, GA (US); David J. Cohen, Ann Arbor, MI (US)

(73) Assignee: BRAINLIKE, INC., Atlanta, GA (US)

(21) Appl. No.: 12/909,633

(22) Filed: Oct. 21, 2010

Related U.S. Application Data
(60) Provisional application No. 61/254,393, filed on Oct. 23, 2009.

(51) Int. Cl. G10L 19/00

(52) U.S. Cl. 704/500; 704/E19.001

(57) ABSTRACT

A computer implemented method for processing audio data communicated between a first device and a second device over a data communication network, where one or more processors are programmed to perform steps include at a first device: receiving time series audio data comprising audio data over a time period; partitioning the audio data in a plurality of time segments; transforming the audio data in the plurality of time segments into a plurality of feature values; transmitting a subset of plurality of feature values over a data communication network; and at a second device: receiving the transmitted plurality of feature values from the data communication network; and transforming the feature values into the time domain to reproduce the time series audio data.

### RELATED APPLICATION

The present application claims priority to U.S. provisional patent application Ser. No. 61/254,393 filed 23 Oct. 2009, which is incorporated herein by reference in its entirety.

### SUMMARY

An aspect of the invention involves a computer implemented method for processing audio data communicated between a first device and a second device over a data communication network, where one or more processors are programmed to perform steps comprising: at a first device: receiving time series audio data comprising audio data over a time period; partitioning the audio data in a plurality of time segments (e.g., snippets); transforming the audio data in the plurality of time segments into a plurality of feature values; transmitting a subset of plurality of feature values over a data communication network; and at a second device: receiving said transmitted plurality of feature values from the data communication network; and transforming said feature values into the time domain to reproduce said time series audio data.

One or more implementations of the aspect of the invention described immediately above may include one or more of the following: the subset of feature values includes only those feature values corresponding to a predetermined or dynamically learned range of feature values (e.g., learned voice frequency); the predetermined or dynamically learned range of feature values is dynamically determined based on analysis of said time series audio data; the transmitted subset of feature values filters the time series audio data to exclude background noise; the transmitted subset of feature values compresses the audio data for reduced bandwidth consumption during transmission over the data communication network.

An additional aspect of the invention involves a computer implemented method for processing audio data, where one or more processors are programmed to perform steps comprising: obtaining time series audio data comprising audio data over a time period; partitioning the audio data in a plurality of time segments; transforming the audio data in the plurality of time segments into a plurality of feature values; identifying a subset of said plurality of feature values corresponding to a predetermined or dynamically learned range of feature values; and storing said subset of said plurality of feature values corresponding to a predetermined or dynamically learned range of feature values to compress the time series audio data.

One or more implementations of the aspect of the invention described immediately above may include one or more of the following: transforming said stored subset of said plurality of feature values corresponding to a predetermined or dynamically learned range of feature values to reproduce said time series audio data; transforming said stored subset of said plurality of feature values corresponding to a predetermined or dynamically learned range of feature values to decompress said time series audio data.

A further aspect of the invention involves an apparatus for processing audio data to be transmitted over a data communication network, the apparatus comprising: a non-transitory computer readable medium configured to store computer executable programmed modules; a processor communicatively coupled with the non-transitory computer readable medium configured to execute programmed modules stored therein; an audio data module stored in the non-transitory computer readable medium and executable by the processor, said audio data module configured to receive time series audio data comprising audio data over a time period; a segment module stored in the non-transitory computer readable medium and executable by the processor, said segment module configured to partition the received time series audio data into a plurality of time segments; a transform module stored in the non-transitory computer readable medium and executable by the processor, said transform module configured to transform the audio data in the plurality of time segments into a plurality of feature values; and a salience module stored in the non-transitory computer readable medium and executable by the processor, said salience module configured to identify a subset of said plurality of feature values corresponding to a predetermined or dynamically learned feature value range.

An implementation of the aspect of the invention described immediately above may include a system comprising the apparatus of the aspect described immediately above communicatively coupled with a second device via a data communication network, wherein said second device further comprises: a non-transitory computer readable medium configured to store computer executable programmed modules; a processor communicatively coupled with the non-transitory computer readable medium configured to execute programmed modules stored therein; a communication module stored in the non-transitory computer readable medium and executable by the processor, said communication module configured to receive said subset of said plurality of feature values from via the data communication network; and a transform module stored in the non-transitory computer readable medium and executable by the processor, said transform module configured to transform the subset of said plurality of feature values corresponding to a predetermined or dynamically learned feature value range into the time domain to reproduce said time series audio data.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a schematic diagram illustrating an Option A operation, where a sensor/sender may transmit all recorded data in the time domain, in the usual way, to a receiver;

FIG. 2 is a schematic diagram illustrating an Option B operation, where the sensor/sender and receiver may divide processing in a way that will both filter out clutter and reduce transmitted data;

FIG. 3 is a schematic diagram illustrating an Option C operation, where filtering and clutter reduction occur without data reduction, as with Option A, but reduction occurs in the sensor/sender unit, instead of the receiver unit;

FIG. 4 is a schematic diagram illustrating an Option D operation, where the sensor/sender unit also inverse transforms the feature values into the time domain, and then plays or displays the reproduced time series values as well;

FIG. 5 is an embodiment of a system 10 according to an embodiment including a first apparatus/device 20 with data storage area 25 and a second apparatus/device 30 with data storage area 35 communicatively coupled by a network 40;

FIG. 6 is an embodiment of an apparatus/device 20 for processing audio data to be transmitted over a data communication network,

FIG. 7 is an embodiment of a second apparatus/device 30 of the system 10;

FIG. 8 is a block diagram illustrating an example wireless communication device that may be used in connection with various embodiments described herein; and

FIG. 9 is a block diagram illustrating an example computer system that may be used in connection with various embodiments described herein.

### DETAILED DESCRIPTION

Certain embodiments as disclosed herein provide for a computer implemented method for processing audio data communicated between a first device and a second device over a data communication network, a computer implemented method for processing audio data, and an apparatus for processing audio data to be transmitted over a data communication network.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

In recent years, the applicants have patented and refined smart sensing methods that efficiently reduce cluttered data to useful information, in real time. With the applicants' sensing methods, real time data can be more readily understood and transmitted data can be reduced. The applicants' sensing methods offer special advantages for time series data. For example, in combined voice recognition and transmission applications, a person's voice may be hard to understand because of background clutter, and transmitting radio quality voice data may require transmission rates over 20,000 bytes per second. The applicants' sensing can continuously learn how to reduce voice data to a smaller number of feature values that are uniquely salient to a given individual. Once these feature values have been computed and transmitted, they can be transformed back to time domain values that reproduce the individual's same voice, but exclude clutter that was present in the original time series data. While many electronic filters are widely used to clarify time series data, Applicants' sensing methods adds a patented process that continuously learns individuals' uniquely salient metrics.

Applicants' sensing methods have now been refined for real time use on small cell phone or remote sensor processors. Meanwhile, signal processing and computing advances have resulted in highly efficient feature extraction methods such as fast Fourier transforms (FFTs). FFTs are now readily available for low power, compact use on the latest generation of remote sensor and cell phone processors as well. These combined advances provide enabling technology for the wireless revolution.

In the human voice recognition case, established methods may be used to convert real time voice data to snippets, at the phoneme or word level. For example, a partitioning process on a caller's cell phone could first parse a person's voice into snippets. Assuming for simplicity that these snippets average one second in length, snippets measured in the time domain would contain an average of 20,000 amplitude values on a one byte gray scale. Established methods may be used to convert those values in the time domain to feature values in other domains. For example, an FFT could transform the 20,000 amplitude values to 20,000 frequency power values, which in turn could be reduced to 1,000 average power feature values. The first such feature value could be the average among frequency power levels between 1 and 20 Hz; the next feature could be the average among power levels between 21 and 40 Hz; and so on.

Applicants' sensing methods can first use an available FFT application that will reduce data to features in this way on a cell phone, during any given call. During each snippet's time span within the call, Applicants' sensing methods can continuously update learned baseline salience values for each such feature. Each salience value will show how much its corresponding feature contributes to accurate voice reproduction, for the person making the call. Applicants' sensing methods can then use an available FFT inverse transform application to convert only those salient features back to sounds like the sender's voice in the time domain. If the feature transformation function and inverse transformation function reside on the same cell phone, the output sound will be filtered so that the individual's learned voice will sound more prominent and background clutter will be reduced. If the transformation function resides on a sending cell phone, and the inverse transformation function resides on a receiving cell phone, then transmitted information will be reduced as well. In that case, only feature values, along with occasionally updated configuration values, will require transmission.

To further explain data reduction for the above example, Applicants' sensing methods may continuously update average feature values for an individual and occasionally send a configuration packet, containing the corresponding most salient frequency ranges for that individual. Meanwhile, for each packet the sending phone would transmit only the power levels for those 1,000 frequency ranges on a one byte gray scale. Resulting data reduction would approach 20 to 1, depending on how often update configuration packets were sent. Update packets in this case could be 1,000 two byte words, pointing to the most salient features among as many as 2¹⁶=65,536 possible features. In the worst case, the packet would be sent with every set of feature values, resulting in a data compression ratio of only 20 to 3. In practice, the packet would require transmission only rarely, resulting in a data compression ratio of nearly 20 to 1.

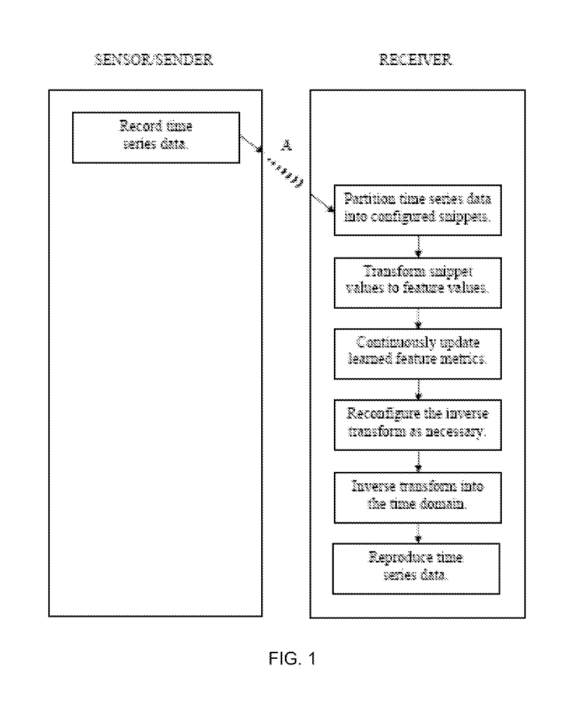

Applicants' sensing components may reside on a sensing and sending unit, a receiver unit, or both, as shown in FIGS. 1 through 4 below. The sensor/sender unit shown in all four figures records the data in the time domain, as shown in the top, left block of each figure. The sensor/sender may then perform other operations shown in blocks below it, or the receiver may perform any or all other operations, as shown in the four figures. Under Option A, which is shown in FIG. 1, the sensor/sender may transmit all recorded data in the time domain, in the usual way. The receiver may then partition the data into time series snippets, like the one second snippets in the above example, as shown. The receiver may then transform snippet values into feature values, like the 1,000 frequency domain feature values in the example. The receiver may then use Applicants' sensing to update learned feature metrics in real time. The receiver may then reconfigure the transform and inverse transform functions according to the most recently transmitted learned metrics. The receiver may then inverse transform the feature values for the snippet back into the time domain, so that the reproduced sound resembles the sender's voice. Finally, the receiver may play or display the reproduced time series values as appropriate.

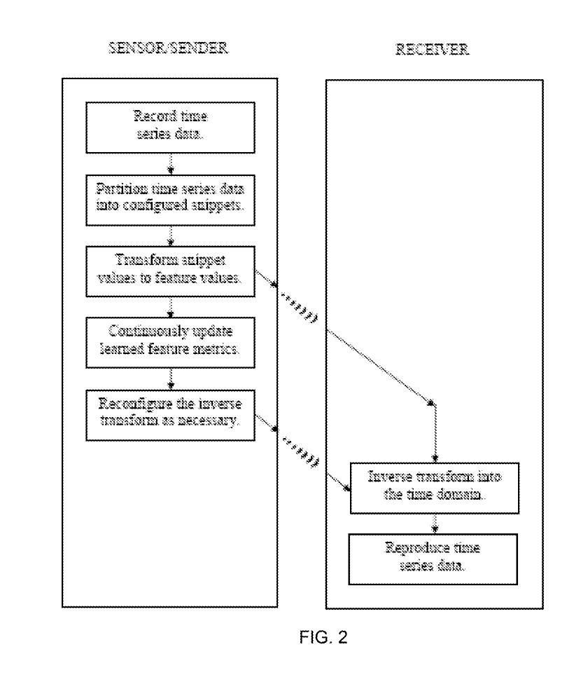

Under Option A, the receiver would filter out clutter frequency components, but the overall system would not reduce transmitted data. Under Option B, as shown in FIG. 2, the sensor/sender and receiver may divide processing in a way that will both filter out clutter and reduce transmitted data. In this case, the sensor/sender may partition the data into snippets as shown, then reduce snippet values to feature values, and then transmit the feature values. The receiver may then inverse transform them into the time domain. The sensor/sender unit may also continuously update feature salience values, reconfigure data reduction as necessary, and transmit reconfigured values to the receiver in order to ensure proper time domain recovery, as shown. The sensor/sender may also occasionally send updated learned metrics, which the receiver would then receive and then reconfigure the inverse transformation function accordingly. The receiver may then play or display the reproduced time series values as appropriate.

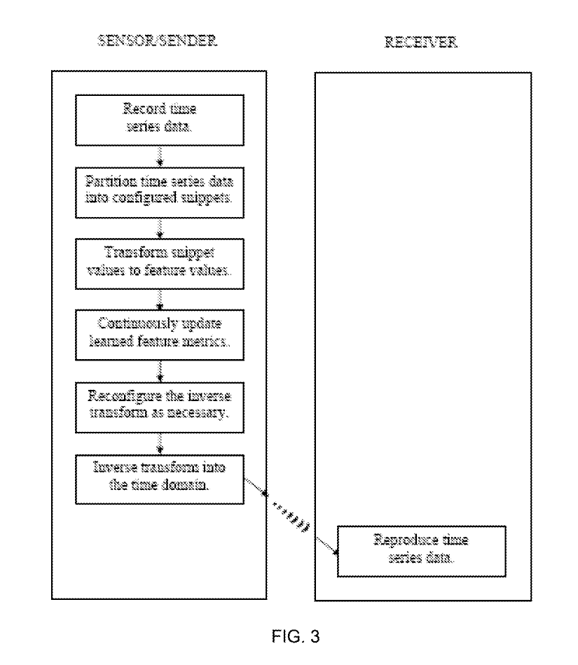

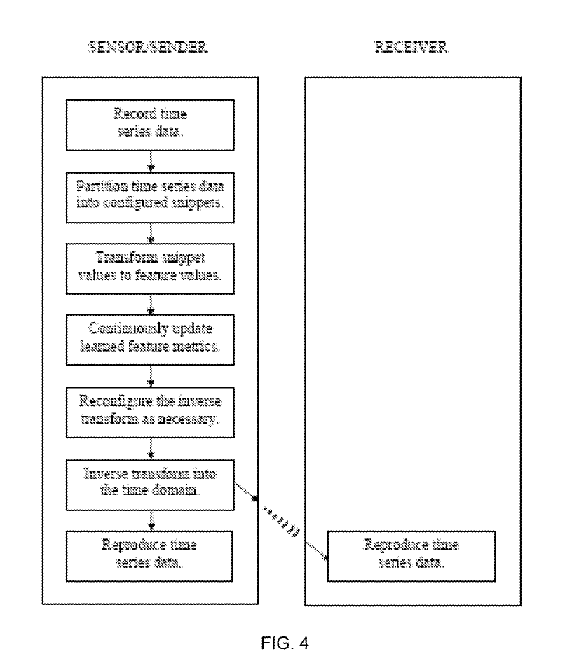

Under Option C, which is shown in FIG. 3, filtering and clutter reduction will occur without data reduction, as with Option A, but reduction will occur in the sensor/sender unit, instead of the receiver unit. Under Option D, shown in FIG. 4, the sensor/sender unit will also inverse transform the feature values into the time domain, and then play or display the reproduced time series values as well.

Available voice recognition and synthesis technology may be coupled with Applicants' sensing to deliver affordable and valuable voice data reduction and filtering solutions, quickly. For example, currently available technology can efficiently convert voice data to text data, resulting in data reduction factors of about 1,000 from radio quality data (assuming that an individual says about 120, eight character words per minute). The text may then be transmitted, along with a feature configuration packet. The configuration packet would indicate features at the receiving should be used and how they should be combined to reproduce the caller's voice.

The features in this case would not be FFTs, but state-of the art features for reproducing a person's voice from text. Any variety of features can be used as well for greater efficiency, such as orthogonal counterparts to FFTs that can be transformed and inverse transformed linearly. Closely held features may be used as well, allowing time series to be encrypted before transmission and then decrypted after transmission. In addition, straightforward extensions of Applicants' sensing usage in the univariate time series case can produce similar clutter and bandwidth reduction in bivariate time series such as video images, as well as higher dimensional time series. Thus, Applicants' sensing may also be applied in many ways, where individuals may be any variety of sensors, generating any variety of time series data in real time.

Technology for converting voice to text and for converting text to a person's voice is not new. Manual voice conversion technology is as old as stenography and manual text conversion is as old as voice impersonation. Automatic voice recognition, transformation, and synthesis have also been studied and developed for decades, resulting in their effective use in available products today. Applicants' sensing adds the key elements of being able learn an individual's metrics in real time and then using the learned metrics to reproduce that individual's time series.

Applicants' sensing has been designed to update learned metrics, including feature means, covariances, and estimation weights quickly and compactly. With Applicants' learned metrics for a person's voice readily available, they can be used to identify and suppress noisy snippets that don't contain the voice, and enhance the person's voice while suppressing noise in snippets that contain both the voice and noise. Learned weights may also be used to impute voice features that may not have been transmitted. In the FIG. 1 case, for example, available bandwidth may allow time series to be transmitted at usually 20 KHz, but sometimes only 10 KHz. In that case, learned weights for imputing higher frequency components for a person from that person's lower frequency components may be used to enhance his or her voice, even though the higher frequency components could not be reproduced from the arriving signal.

The numbers presented in the above example were intended to illustrate how Applicants' sensing can reduce data. Automated feature refinement methods may reduce the number of features substantially, improving data reduction to factors above 20 to 1. In practice, transmission bandwidth, along with voice reproduction accuracy, will decrease with the number of salient features being transmitted. Applicants' sensing sensing applications may easily be configured to make the number of salient features configurable, so that cell phone users and network providers can adjust bandwidth as well as filtering accordingly.

In summary, patented Applicants' sensing technology is capable of uniquely filtering and reducing time series data, in a general purpose form that can be efficiently deployed on cell phone or remote sensor processors. Voice clutter and data reduction is one key application, but Applicants' sensing can add similar value in many other time series applications, ranging from video surveillance to health care monitoring.

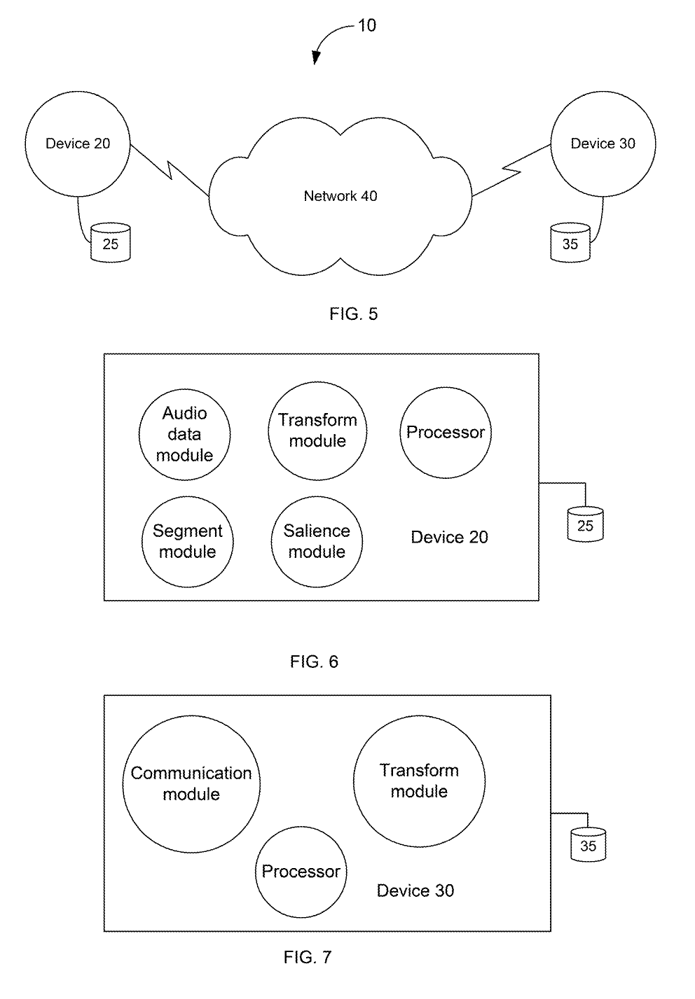

FIG. 5 is an embodiment of a system 10 according to an embodiment including a first apparatus/device 20 with data storage area 25 and a second apparatus/device 30 with data storage area 35 communicatively coupled by a network 40. The first apparatus/device 20 and the second apparatus/device 30 may be the sensor/sender and the receiver shown/described herein or vice versa.

FIG. 6 is an embodiment of an apparatus/device 20 for processing audio data to be transmitted over a data communication network.

FIG. 7 is an embodiment of a second apparatus/device 30 of the system 10.

In an aspect of the invention, the device/apparatus 20 processes audio data to be transmitted over a data communication network. The device/apparatus 20 includes a non-transitory computer readable medium 25 configured to store computer executable programmed modules; a processor communicatively coupled with the non-transitory computer readable medium configured to execute programmed modules stored therein; an audio data module stored in the non-transitory computer readable medium and executable by the processor, said audio data module configured to receive time series audio data comprising audio data over a time period; a segment module stored in the non-transitory computer readable medium and executable by the processor, said segment module configured to partition the received time series audio data into a plurality of time segments; a transform module stored in the non-transitory computer readable medium and executable by the processor, said transform module configured to transform the audio data in the plurality of time segments into a plurality of feature values; and a salience module stored in the non-transitory computer readable medium and executable by the processor, said salience module configured to identify a subset of said plurality of feature values corresponding to a predetermined or dynamically learned feature value range.

An implementation of the aspect of the invention described immediately above may include the system 10 comprising the device/apparatus 20 of the aspect described immediately above communicatively coupled with the second device/apparatus 30 via a data communication network, wherein said second device 30 further comprises: a non-transitory computer readable medium configured to store computer executable programmed modules; a processor communicatively coupled with the non-transitory computer readable medium configured to execute programmed modules stored therein; a communication module stored in the non-transitory computer readable medium and executable by the processor, said communication module configured to receive said subset of said plurality of feature values from via the data communication network; and a transform module stored in the non-transitory computer readable medium and executable by the processor, said transform module configured to transform the subset of said plurality of feature values corresponding to a predetermined or dynamically learned feature value range into the time domain to reproduce said time series audio data.

Another aspect of the invention involves a computer implemented method for processing audio data communicated between the first device/apparatus 20 and the second device/apparatus 30 over the data communication network 40, where one or more processors are programmed to perform steps comprising: at the first device 20: receiving time series audio data comprising audio data over a time period; partitioning the audio data in a plurality of time segments (e.g., snippets); transforming the audio data in the plurality of time segments into a plurality of feature values; transmitting a subset of plurality of feature values over the data communication network 40; and at the second device 30: receiving said transmitted plurality of feature values from the data communication network 40; and transforming said feature values into the time domain to reproduce said time series audio data.

One or more implementations of the aspect of the invention described immediately above may include one or more of the following: the subset of feature values includes only those feature values corresponding to a predetermined or dynamically learned range of feature values (e.g., learned voice frequency); the range of feature values is either predetermined from prior analysis of historical, audio time series data or dynamically learned based on analysis of said time series audio data; the transmitted subset of feature values filters the time series audio data to exclude background noise; the transmitted subset of feature values compresses the audio data for reduced bandwidth consumption during transmission over the data communication network 40.

An additional aspect of the invention involves a computer implemented method for processing audio data, where one or more processors are programmed to perform steps comprising: obtaining time series audio data comprising audio data over a time period; partitioning the audio data in a plurality of time segments; transforming the audio data in the plurality of time segments into a plurality of feature values; identifying a subset of said plurality of feature values corresponding to a predetermined or dynamically learned range of feature values; and storing said subset of said plurality of feature values corresponding to a predetermined or dynamically learned range of feature values to compress the time series audio data.

One or more implementations of the aspect of the invention described immediately above may include one or more of the following: transforming said stored subset of said plurality of feature values corresponding to a predetermined or dynamically learned range of feature values to reproduce said time series audio data; transforming said stored subset of said plurality of feature values corresponding to a predetermined or dynamically learned range of feature values to decompress said time series audio data.

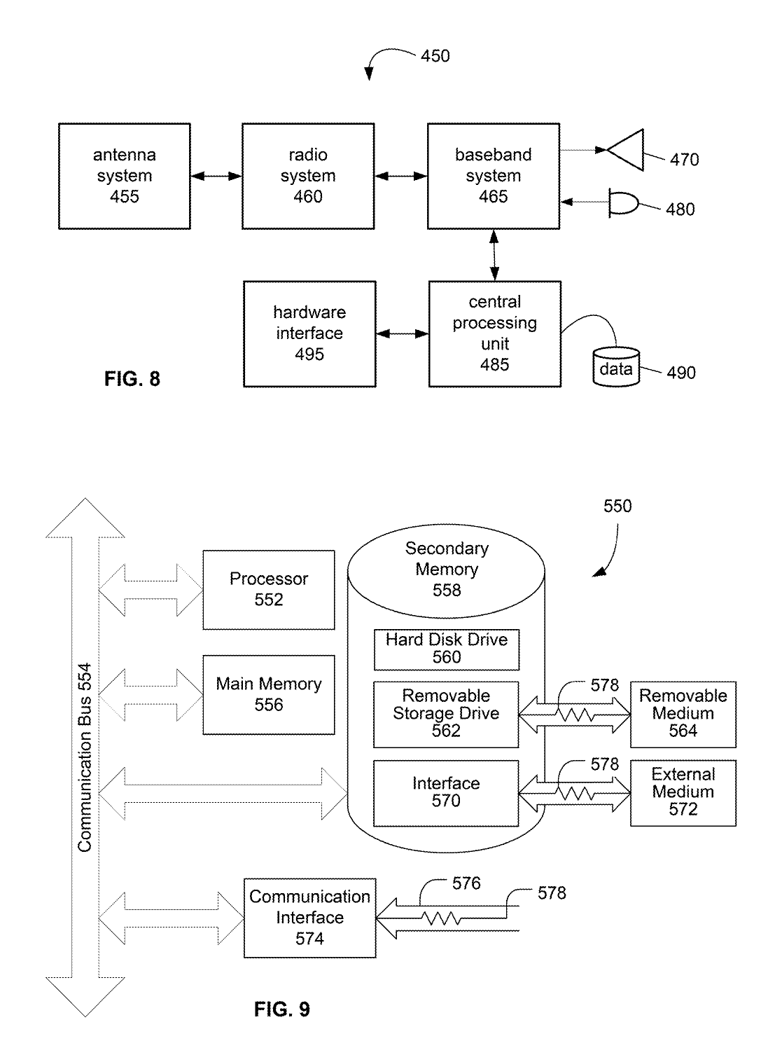

FIG. 8 is a block diagram illustrating an example wireless communication device 450 that may be used in connection with various embodiments described herein. For example, the wireless communication device 450 may be used in conjunction with one or both of the sensor/sender, receiver, devices/apparatus 20, 30. However, other wireless communication devices and/or architectures may also be used, as will be clear to those skilled in the art.

In the illustrated embodiment, wireless communication device 450 comprises an antenna system 455, a radio system 460, a baseband system 465, a speaker 470, a microphone 480, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communicate over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) that were previously described with respect to FIGS. 6 and 7.

In this description, the term “computer readable medium” is used to refer to any media used to provide executable instructions (e.g., software and computer programs) to the wireless communication device 450 for execution by the central processing unit 485. Examples of these media include the data storage area 490, microphone 480 (via the baseband system 465), antenna system 455 (also via the baseband system 465), and hardware interface 495. These computer readable media are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a fire wire port, a USB port, a Bluetooth or infrared wireless unit, or any of a variety of wired or wireless access mechanisms. Examples of hardware that may be linked with the device 450 include data storage devices, computing devices, headphones, microphones, and the like.

FIG. 9 is a block diagram illustrating an example computer system 550 that may be used in connection with various embodiments described herein. For example, the computer system 550 may be used in conjunction with sensor/sender, receiver, devices/apparatus 20, 30. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, a coprocessor, or several of said processors operating in parallel, in pipelined fashion, or both. Such additional processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any non-transitory computer readable storage media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These non-transitory computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A computer implemented method for processing audio data communicated between a first device and a second device over a data communication network, where one or more processors are programmed to perform steps comprising:
at a first device:
receiving time series audio data comprising audio data over a time period;
partitioning the audio data in a plurality of time segments;
transforming the audio data in the plurality of time segments into a plurality of feature values;
transmitting a subset of plurality of feature values over a data communication network; and
at a second device:
receiving said transmitted plurality of feature values from the data communication network; and
transforming said feature values into the time domain to reproduce said time series audio data.

2. The method of claim 1, wherein the subset of feature values includes only those feature values corresponding to a predetermined range of feature values.

3. The method of claim 2, wherein the predetermined range of feature values is dynamically learned based on analysis of said time series audio data.

4. The method of claim 2, wherein the transmitted subset of feature values filters the time series audio data to exclude background noise.

5. The method of claim 2, wherein the transmitted subset of feature values compresses the audio data for reduced bandwidth consumption during transmission over the data communication network.

6. A computer implemented method for processing audio data, where one or more processors are programmed to perform steps comprising:
obtaining time series audio data comprising audio data over a time period;
partitioning the audio data in a plurality of time segments;
transforming the audio data in the plurality of time segments into a plurality of feature values;
identifying a subset of said plurality of feature values corresponding to a predetermined range of feature values; and
storing said subset of said plurality of feature values corresponding to a predetermined or dynamically learned range of feature values to compress the time series audio data.

7. The method of claim 6, further comprising transforming said stored subset of said plurality of feature values corresponding to a predetermined or dynamically learned range of feature values to reproduce said time series audio data.

8. The method of claim 6, further comprising transforming said stored subset of said plurality of feature values corresponding to a predetermined or dynamically learned range of feature values to decompress said time series audio data.

9. An apparatus for processing audio data to be transmitted over a data communication network, the apparatus comprising:
a non-transitory computer readable medium configured to store computer executable programmed modules;
a processor communicatively coupled with the non-transitory computer readable medium configured to execute programmed modules stored therein;
an audio data module stored in the non-transitory computer readable medium and executable by the processor, said audio data module configured to receive time series audio data comprising audio data over a time period;
a segment module stored in the non-transitory computer readable medium and executable by the processor, said segment module configured to partition the received time series audio data into a plurality of time segments;
a transform module stored in the non-transitory computer readable medium and executable by the processor, said transform module configured to transform the audio data in the plurality of time segments into a plurality of feature values;
a salience module stored in the non-transitory computer readable medium and executable by the processor, said salience module configured to identify a subset of said plurality of feature values corresponding to a predetermined or dynamically learned feature value range.

10. A system comprising the apparatus of claim 9 communicatively coupled with a second device via a data communication network, wherein said second device further comprises:
a non-transitory computer readable medium configured to store computer executable programmed modules;
a processor communicatively coupled with the non-transitory computer readable medium configured to execute programmed modules stored therein;
a communication module stored in the non-transitory computer readable medium and executable by the processor, said communication module configured to receive said subset of said plurality of feature values from via the data communication network; and
a transform module stored in the non-transitory computer readable medium and executable by the processor, said transform module configured to transform the subset of said plurality of feature values corresponding to a predetermined feature value range into the time domain to reproduce said time series audio data.
